(19) United States
(12) Patent Application Publication
(10) Pub. No.: US 2005/0164761 A1
(43) Pub. Date: Jul. 28, 2005

(54) Poker game managing method

(76) Inventor: Liu Gui Tain, Los Angeles, CA (US)

Correspondence Address: RAYMOND Y. CHAN, 108 N. YNEZ AVE., SUITE 128, MONTEREY PARK, CA, 91754, US

(21) Appl. No.: 10/762,149

(22) Filed: Jan. 22, 2004

(51) Int. Cl. G06F 17/00

(52) U.S. Cl. 463/13

(57) ABSTRACT

A method for managing a card game supported by a poker dealing device and central management unit, a computerized-information-processing center includes the following steps. Read the playing card that is being dispensed from the poker dealing device to generate a card signal representing a card value of the playing card in such a manner that the other playing cards, which have not been dispensed from the poker dealing device, remain in secret. Send the card signal to the central management unit by means of remote communication. Receive the card signal with a signal receiving link of the central management unit. Process the card signal to record the card values of the playing cards that have been dispensed from the poker dealing device with the central management unit, such that the central management unit is capable of tracking the card values of each hand for a card game, thereby reducing a risking of cheating with reference to the recorded card values.

### BACKGROUND OF THE PRESENT INVENTION

1. Field of Invention

The present invention is related to a poker managing method for reading the playing cards dispensed out of a poker dealing device to generate a card signal representing the values of playing card, and more particularly to a method for sending the card signal to a remote place where a central management unit locates for further processing for management purposes.

2. Description of Related Arts

Card games have a long history as an entertainment, and many of them are potentially suitable for gambling. Poker, baccarat and blackjack are among the most popular mean of gambling in casinos. In spite of their own rules, they all based on a standard deck of playing cards, which includes fifty-two cards separated into four suits, clubs, spades, hearts and diamonds. The cards are ranked from high to low in the order of Ace, King, Queen, Jack, 10, 9, 8, 7, 6, 5, 4, 3 and 2. Sometimes, more than one deck of cards is used for certain card games. According to the rules, the combination of the plays cards determines who wins and who loses.

In a poker game, each player places an initial bet into the pot before the cards are dealt. The dealer then deals the cards face down around the table to the player for many times until each player has five cards, i.e., a hand. In the course of dealing the cards, the players decide to place bets or withdraw from the game and the winner takes the pot. The values of hands are ranked from high to low in the following order: Royal Flush, Straight Flush, Four of a Kind, Full Hose, Flush, Straight, Three of a Kind, Two Pair and One Pair. Royal Flush is composed of 10, Jack, Queen, King and Ace in the same suit. Straight Flush is composed of five cards in numerical order, all of the same suit. Four of a Kind is composed of four cards of the same numerical rank and another random card. Full House is composed of three cards having the same numerical rank, and two remaining cards also having the same numerical rank. Flush is composed of five cards of the same suit. Straight is composed of five cards in numerical order, regardless of their suits. Three of a Kind is composed of three cards of the same numerical rank, and two random cards that are not a pair. Two Pair is composed of two sets of pairs, and another random card. One pair is composed of one pair and three random cards.

In a Blackjack game, all face cards have a value of 10. Aces have a value of either 1 or 10, and other cards are worth their face value. The dealer deals card to players until they are satisfied. If the total value of the player's cards exceed 21, the player “bust” and loses her bet. If the total value is higher than that of the dealer, the player wins. If the total value is lower than that of the dealer, the player loses. If the player has the same total value as the dealer, it is a push. The dealer must draw cards until she has at least 17 or higher. In other words, if the dealer gets 16, she must draw another card.

The goal of Baccarat is to assemble a hand of two or three cards with a point value as close to nine as possible. Usually, the game is played by a banker and player. The banker deals two hands of two cards each, face down. These hands are for the banker plus the dealer's own hand. Other participants at the table may bet on either hand or both to beat the banker's hand. If the player declares “banco”, it means they are betting the total value of the bank's funds and all other bets are withdrawn.

All the abovementioned card games require extensive dealing of cards and lengthened procedure of betting, in which some game participants may be able to gain illegitimate advantages by cheating. In order to make cheating more difficult, nowadays, most casinos are using card dealing shoe to reduce the exposure of the cards to the participant's hands. Traditionally, the card dealing shoe is shaped as an elongated box having a cavity for receiving cards. A chute is disposed in the cavity in a downhill manner and a wedge is placed on the chute pushing the cards received therein against a dispensing slot of card dealing shoe. The dealer slides one card through the dispensing slot at one time and delivers the dispensed card to the players and herself. Because the cards are preserved in the cavity of card dealing shoe, they are protected from tempering by the participants of the card game. Furthermore, the card is dispensed in such a way the each card leaving the card dispensing shoe has its face down on the table. In other words, no one is able to learn the value the dispensed card by a quick glance. Thus, the card dealing shoe reduces the risk of cheating in a card game.

Although the card dealing shoe helps reduce cheating for card games, it is not perfect. Some skillful people may be capable of switching the dealt cards with prepared substitutes and therefore acquires a better hand in violation of the game rules. Sometimes, the cheating is even done by the dealer, who is usually an employee of casino. For example, the dealer may conspire with a player and intentionally commits certain technical faults in dealing the cards. As a general practice, if a round of dealing of cards is faulty, the players of the round can challenge it and may be able to set aside the result of the round. The secret knowledge that a technical fault is committed gives the player an illegitimate advantage that she may be willing to place a big bet because she knows that once she loses, she can challenge the round and has a good chance to successfully set aside the result. These are the forms of cheating that the traditional dealing shoe is not capable of remedying.

A conventional solution to the aforementioned issues can be found in U.S. Pat. No. 6,582,301 (hereinafter as “the '301 patent”) entitled as “System Including Card Game Dispensing Shoe With Barrier And Scanner, And Enhanced Card Gaming Table Enabling Waging By Remote Bettors.” The patent discloses a game monitoring and display device for a card game, which comprises a shoe including a housing having an outlet slot, and a scanner disposed in the housing to scan each card dispensed through the outlet slot and to generate a scanner signal representative of identity of each card.

Although the '301 patent provides a scanner to the card dealing shoe to scan the cards and therefore allowing a player to participate a card game remotely, it has some drawbacks. The scanner is disposed in the housing of card dealing shoe, so that there is a chance that the card received in the housing would be scanned by the scanner, either accidentally or intentionally. The dealer may have a chance to know the values of the cards before they are dealt out of the card dealing shoe. As a result, there is a slight risk of cheating with the card dealing shoe. In order to get the value of the cards, the scanner scans the image first to generate image signals and some circuitry provided within the card dealing shoe processes the image signals for recognition of the values they represent. The image recognition process is time-consuming and computing-resource-demanding. Further, it is not unusual that the results of the image recognition would be incorrect.

In addition to reducing the risk of cheating, the casino may want to collect as much information as possible for card games. Because a card game is basically gambling on probability, by collecting the information the card game for analytical and managerial purposes, the casino may be able to better understand the profitability of the tables on which the card games are played. The collected information also helps the casino to early identify unusually happenings that may indicate managerial problems.

Thus, what is needed is a method that is capable of identifying the values of the card dealt in a card game for further processing for management purposes in order to prevent cheating.

### SUMMARY OF THE PRESENT INVENTION

An objective of the present invention is to provide a method that reads the value of the playing card, which is being dispensed out of a poker dealing device, to generate a card signal and transferred the signal to a central management unit for data processing for managerial purposes.

Another objective of the present invention is to provide a method that indicating the card values with card indicators implemented on the face side of playing cards, wherein the card indicator is to be used together with a card reader of the poker dealing device in order to facilitate the reading of cards.

Another objective of the present invention is to provide a method that converts the card signal from an analog form into a digital form for purpose of data processing and communication over a long distance.

Another objective of the present invention is to provide a method that amplifies the card signal from an analog form into a digital form for purpose of data processing and communication over a long distance.

Another objective of the present invention is to provide a method that adopts means of remote communication for transmitting the card signal from the poker dealing device to the central management unit over a long distance.

Another objective of the present invention in to provide a method that displays the values of playing cards for management personnel operating the central management unit to monitor the card game.

Another objective of the present invention is to provide a method that inputs command into the central management unit to direct processing of the card signal in order to improve and remedy the card game.

Another objective of the present invention is to provide a method that detects the wagered bet to generate a bet signal and transferred the signal to a central management unit for calculating a winning and losing result of the card game.

Another objective of the present invention is to provide a method that implements a bet sensor on a predetermined betting area of the poker table in order for detecting the bet wagered thereon.

Accordingly, in order to accomplish the above objects, the present invention provides a method for managing a card game by a poker dealing device through a central management unit, comprising the steps of: (a) reading a card value of each playing card once the playing card is dispensed from the poker dealing device; (b) transmitting the card values of the playing cards respectively dispensed from the poker dealing device as card signals to the central management unit; and (c) recording the card signals to form a game record corresponding to the card game in such a manner that the card game is capable of being tracked by the card values of each hand of the card game, so as to reduce a risk of cheating in response to the playing cards dispensed from the poker dealing device.

These and other objectives, features, and advantages of the present invention will become apparent from the following detailed description, the accompanying drawings, and the appended claims.

### BRIEF DESCRIPTION OF THE DRAWINGS

FIG. 1 is an exemplary illustration of a card dealing system comprising the poker dealing device, according to a preferred embodiment of the present invention.

FIG. 2 is a functional block diagram of the card dealing system that comprises a poker dealing device, central management unit and poker table, according to the preferred embodiment of the present invention.

FIG. 3 is a top view of the poker dealing device according to the preferred embodiment of the present invention.

FIG. 4 is a side view of the poker dealing device according to the preferred embodiment of the present invention.

FIG. 5 is a perspective view of the poker dealing device according to the preferred embodiment of the present invention.

FIG. 6 is a top view of an exemplary poker table according to the preferred embodiment of the present invention.

FIG. 7 is a flowchart of the disclosed method supported by the card dealing system according to the preferred embodiment of the present invention.

### DETAILED DESCRIPTION OF THE PREFERRED EMBODIMENT

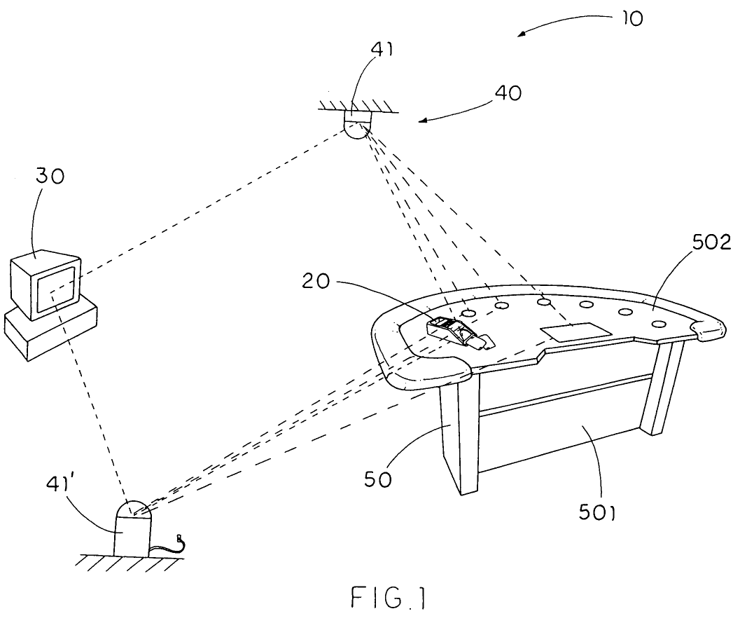

Referring to FIGS. 1 through 6, a poker game managing method employed in a casino for better managing and regulating a card game through a card dealing system 10 according to one preferred embodiment of the present invention is illustrated. The card dealing system 10 comprises a poker dealing device 20, a central management unit 30, a computerized device, communication means 40 and a poker table 50.

The poker game managing method comprises the following steps.

(1) Read a card value of each playing card 202 once the playing card 202 is dispensed from the poker dealing device 20.

(2) Transmit the card values of the playing cards 202 respectively dispensed from the poker dealing device 20 as card signals to the central management unit 30.

(3) Record the card signals to form a game record corresponding to the card game in such a manner that the card game is capable of being tracked by the card values of each hand of the card game, so as to reduce a risk of cheating in response to the playing cards dispensed from the poker dealing device 20.

Accordingly, the card game is incorporated with at least a deck of playing cards 202 each having a face side and a card value provided thereon. Each deck of playing cards 202 includes four sets of face cards and four sets of numerical value cards. Each set of the face cards includes an Ace, a Jack card, a Queen card, and a King card and each of said numerical value cards includes a 2 card, a 3 card, a 4 card, a 5 card, a 6 card, a 7 card, a 8 card, and a 9 card. The four sets of numerical value cards and the four sets of face cards of each deck can also be identified by different face signs to include a SPADE group set, a HEART group set, a CLUB group set, and a DIAMOND group set or other kinds of signs.

The poker dealing device 20 is capable of dispensing the playing cards 202 to the participants, including the players and dealers, of the card game. The participants sit around the poker table 50, receive playing cards dealt from the dealer and place bets on the poker table 50.

According to the preferred embodiment, the poker dealing device 20 comprises a housing 201 having a receiving cavity 207 for receiving the playing cards 202, and a dispensing slot 203 communicating with the receiving cavity 207 for allowing the playing cards 202 to be dispensed therethrough in a one-by-one manner.

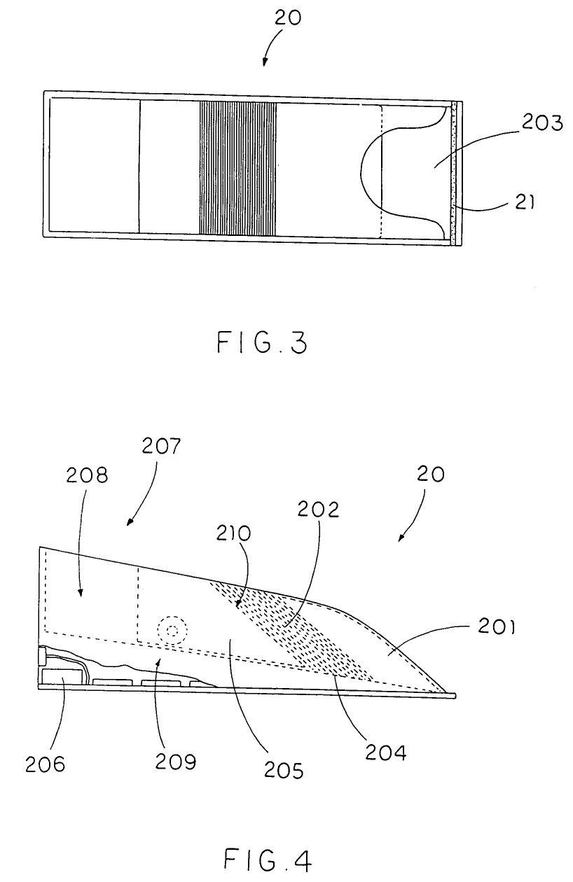

The housing 201 further comprises a circuit chamber 209 and a divider 204 inclinedly disposed in the receiving cavity 207 into a card chamber 208 for receiving the playing cards 202 therein. A wedge 205 having a sloped front side 210 is slidably placed on the divider 204 behind the playing cards 202 with respect to the dispensing slot 203. The gravity of the wedge 205 and slope of the divider 204 pushes the playing cards 202 against the dispensing slot 203, so as to allow the playing cards being dispensed through the dispensing slot 203 in a one-by-one manner, as shown in FIGS. 3 and 4.

In step (1), the poker dealing device 20 further comprises a card reading device comprising a card reader 21 provided at the dispensing slot 203 at a position out of the receiving cavity 207 for reading the card value of the playing card 202 at a time when the playing card 202 is dispensed out of the receiving cavity 207 through the dispensing slot 203, so as to guarantee the card values of the playing cards 202 in the receiving cavity 207 in a secrete manner until the playing cards 202 are dispensed out of the receiving cavity 207 through the dispensing slot 203.

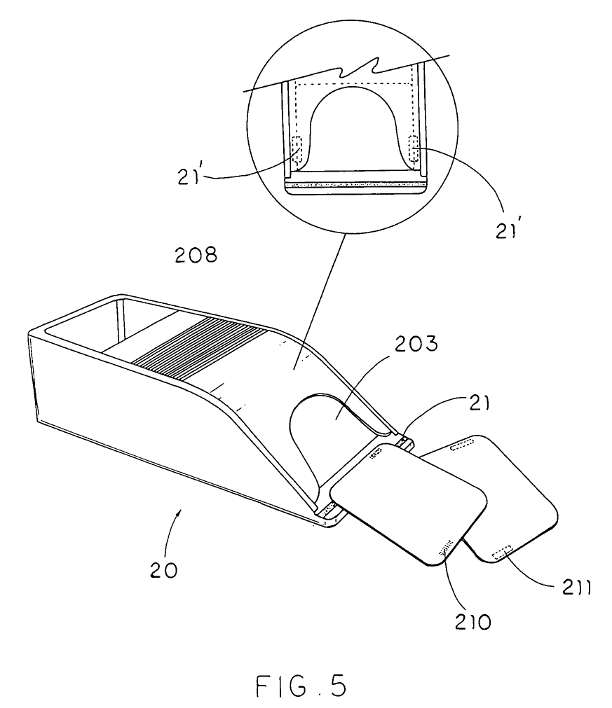

Referring to FIG. 5, the card reader 21 is disposed out of the receiving cavity 207 at the front line of dispensing slot 203, wherein the card reader 21 is activated only when a playing card 202 moves thereacross. The playing cards 202 are dispensed with their faces facing down. This arrangement allows the card reader 21 to read the playing card 202 that is dispensing through the dispensing slot 203, and the playing cards 202 stored in the card chamber 208 remains secret. As a result, the chance of cheating by a dealer or casino personnel stealthily learns the values of cards received in the receiving cavity 207 with the card reader 21. As an alternative, the card reader 21′ may be place at two front sides of dispensing slot 203, wherein the card reader 21′ is also activated only when a playing card 202 moves thereacross.

The card reading device further comprises an electric circuitry 206 supported within the circuit chamber 209 of the housing 201 to electrically connect with the card reader 21 for communicating with the computerized device. The electric circuitry 206 comprises a digital encoder 22 encoding a card signal read from the card reader 21 in a digital form and a signal transmitter 24 electrically connected to the digital encoder 22 for transmitting the card signal to the computerized device as shown in step (2).

The arrangement of card reader 21 makes sure that only the playing cards that have already been dealt would be read and understood. Thus, there is no risk that the dealer would know the values and suits of all playing cards 202 stored in the card chamber 208 before they are dispensed, so that the public can be sure that the dealer cannot cheat via the card reader 21. Moreover, the poker dealing device 20 is so programmed that the card signals representing the values of the playing cards that are already dealt would not be transmitted until all the cards are dealt for a card game when no one can gain illegitimate advantages by intercepting the transmitted card signals. As a result, the disclosed poker dealing device 20 is able to gain the public's faith in the fairness of card games and eventually make a contribution to the casino's success.

According to preferred embodiment, the card reader 21 is used in association with a card indicator disposed in association with the playing cards 202 for facilitating the card reading of the card reader 21. The card indicator is adapted for forming at the face side of each of the playing cards 202 to represent the card value thereof, wherein the card indicator is positioned aligning with the card reader 21 such that the card reader 21 reads the card indicator when the respective playing card 202 is dispensed out of the receiving cavity 207 through the dispensing slot 203.

Two solutions are provided for the card indicators. According to one solution, the card indicators are embodied as a set of barcode indicators, each of which represents the value and suit of its respective playing card 202. The card indicator comprises a barcode 210 adapted for printing on the face side of each of the playing cards 202 to represent the card valve thereof, wherein the card reader 21 is an optical scanning device reading the barcode 210 of the card indicator on each of the playing cards 202.

Each barcode 210 is attached on the face side of its respective playing card 202. When the playing card 202 moves across the card reader 21, it projects a beam to the barcode 210 of the card indicator and receives the reflection of the beam to generate the analog card signal representing the value and suit of the playing card 202.

According to another solution, the card reader 21 communicates with the card indicators by means of magnetic communication, each of which represents the value and suit of its respective playing card. The card indicator comprises a magnetic-sensitive layer 211 adapted for attaching on the face side of each of the playing cards 202 to represent the card valve thereof, wherein the card reader 21 is a magnetic-sensor reading the magnetic-sensitive layer 211 of the card indicator on each of the playing cards 202.

Each magnetic-sensitive layer 211 is disposed between a face layer and a back layer of its respective playing card. When the playing card 202 moves across the card reader 21, it identifies the value and suit represented by the magnetic-sensitive layer 211 to generate the analog card signal representing the value and suit of the playing card.

The card indicators ease the process of card reading by avoiding excessive imaging processing. Otherwise, the card reader 21 would have had to catch the whole image data of playing card, and analyze the image data to know what the value and suit of the playing card are. Thus, the card indicators may save the processing time to provide better real-time management, and reduce the manufacturing cost. It is noted that, the card reader 21 can be any traditional image sensor that detects the image of the playing cards 202 to generate image signals for further processing of image recognition.

The digital encoder 22 comprises an analog/digital converter converting the analog card signal into the digital card signal for purposes of quality of signal communication and ease of data processing. The electric circuitry 206 further comprises an amplifier 23 amplifying the digital card signal as an amplified digital card signal that is more recognizable for a circuitry, and therefore promoting the convenience of signal communication and data processing. The amplified digital card signal has the advantages of less susceptible to noise than an analog signal in the course of signal communication, and compatible for calculation of processors. In other words, the card signal is encoded into a digital form before the card signal is transmitted to the central management unit 30 in step (2).

In step (2), the signal transmitter 24 transmits the amplified digital card signal to a remote location, where the central management unit 30 locates at the computerized device, for further data processing. The transmission of the amplified digital card signal is in the form of either infrared signal or radio frequency. It is noted that the signal transmitter 24 may transmit the amplified digital card signal by means of wire connection.

Accordingly, the signal transmitter 24 is an infrared transmitting device adapted for sending the card signal as an infrared signal to the computerized device, such that the signal transmitter 24 functions as a wireless communication link for wirelessly communicating the card reading device with the computerized device.

Alternatively, the signal transmitter 24 is a radio frequency transmitting device adapted for sending the card signal as a radio frequency to the computerized device, such that the signal transmitter 24 functions as a wireless communication link for wirelessly communicating the card reading device with the computerized device.

The communication means 40 is arranged for communicatively transmitting the card signal from the card reading device to the central management unit 30 in such a manner that a game record is generated at the central management unit 30 based on the card signal read from the card reader 21 with respect to the playing cards 202 dispensed from the poker dealing device 20 in the card game.

The communication means 40 comprises a signal receiver 41 receiving the card signal from the poker dealing device 20 wherein the signal receiver 41 is linked to the central management unit 30 such that the card signal sent from the poker dealing device 20 is sent to the central management unit 30 through the communication means 40. In other words, the communication means 40 is capable of receiving signals from the poker dealing device 20 and transmitting the same to the central management unit 30 so as to extend the communication range of the central management unit 30 and the poker dealing device 20.

According to the preferred embodiment, the signal receiver 41 is affixed on the roof of a game room hosting the poker table 50 and poker dealing device 20, as shown in FIG. 1. The signal receiver 41′ can also be placed on the ground of the game room as an alternative of the preferred embodiment.

Accordingly, the signal receiver 41 is embodied as an infrared receiver linked with the central management unit 30, such that the signal transmitter 24 functions as a wireless communication link between the card reading device and the central management unit 30 through the signal receiver 41 of the communication means 40.

Alternatively, the signal receiver 41 is a radio frequency receiver linked with the central management unit 30, such that the signal transmitter 24 functions as a wireless communication link between the card reading device and the central management unit 30 through the signal receiver 41 of the communication means 40. It is worth to mention that the communication means 40 can be a set of wires connecting the above-mentioned elements together instead of wireless communication.

In step (3), the central management unit 30 is arranged for generating the game record regarding the playing cards 202 that have been dealt in the card game. The central management unit 30 comprises a signal receiving link 31, a central processing unit 32, data storage medium 33, a result display 34 and a control panel 35. The signal receiving link 31 receives the amplified digital data signal transmitted from the signal transmitter 24 through the signal receiver 41 of the communication means 40, and forwards the signal to the central processing unit 32, which responds to the amplified digital card signal to perform several functions. Accordingly, a game rule is preloaded in the central processing unit 32 such that the card signal is input into the central processing unit to generate the game record regarding the playing cards 202 that have been dealt in the card game.

The information related to the playing cards 202 is recorded in the data storage medium 23, wherein the records comprise the value and suit of each playing card 202 dealt from the poker dealing device 20, the order of card, the relationship of the card in association with other cards for making up a hand for a particular round of card game, and status of winning and losing for a round of card game.

According to the preferred embodiment, the result display 34 displays the game record regarding the status of winning and losing and odds after the round of card game is over. The result display 34, which is linked to the central processing unit 32, selectively shows the records of information regarding the playing cards 202 on a screen according to a predetermined program that is performed by the central processing unit 32.

The control panel 35 receives input commands of handling the records regarding the value and suit of each playing card dealt from the poker dealing device 20, the order of card, the relationship of the card in association with other cards for making up a hand for a particular round of card game, and status of winning and losing for a round of card game. Some input commands may be converted into digital command signals, which are transmitted by the signal receiving link 31 to a remote place where the card game under the monitor of the central management unit 30 is going on, so that the dealer may take certain actions to improve or remedy the card game according the input commands.

The association of the poker dealing device 20 with the central management unit 30 provides certain advantages. Because the value and suit of each playing card 202 that has been dispensed from the poker dealing device 20 is known by the central management unit 30, the chance of cheating by secretly switching the playing card 202 is reduced. The records preserved in the data storage medium 33 provides trusted history of every card games as a basis for challenges by the players. This reduces the chance of cheating that the dealer and players conspire to challenge the card games in order to invalidate results of card games. Because the fairness of card games is one of the most important factors contributing to public's faith on the games, the present invention helps to build up public's faith and therefore contributing to the success of a casino that adopts the card dealing system.

According to the preferred embodiment, the poker game managing method further comprises the following steps.

(1′) Detect a bet wagered within a betting area of a poker table to generate a bet signal representing a value of said bet.

(2′) Transmit the bet signal to the central management unit 30.

(3′) Record the bet signal to generate the record in the central management unit 30 such that the card game is capable of being tracked by the bet signals of each hand of the card game for determining a winning and losing result of each hand of the card game with respect to the card values of each hand of the card game.

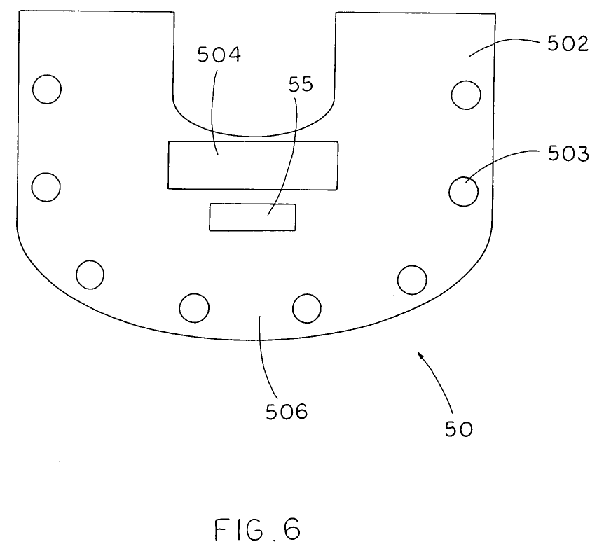

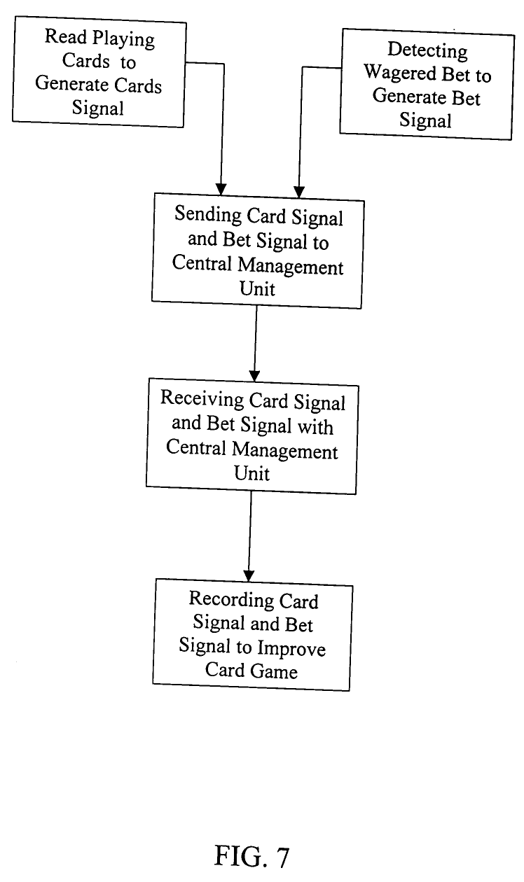

As shown in FIGS. 1 and 6, the poker table 50 comprises a tabletop 502 having a top surface 506 for dealing the playing cards 202 and placing bets, and supporting member 501 for structurally supporting the tabletop 506, wherein the betting areas 503 are spacedly provided on the tabletop 502 restricting the bet within one of the betting areas 503.

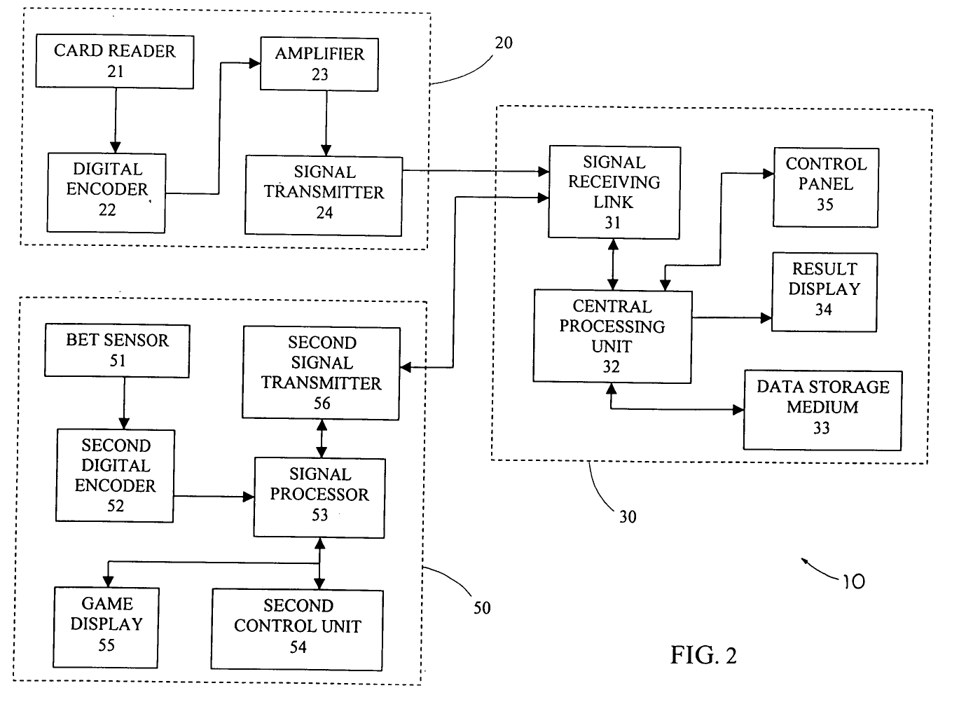

In step (1′), a plurality of bet sensors 51 are respectively disposed in association with the betting areas 503 for detecting the placed bets thereon to generate the bet signal representing the values of placed bets. Accordingly, the bet sensors 51 respectively detects the bets placed by players and dealer to generate analog bet signals representing the values of the placed bets, as shown in FIG. 2. In this preferred embodiment, the bet sensor 51 detects the weight of chips wagered to generate the analog bet signal representing the value of the placed bet. It is noted that other solutions may be adopted for the bet sensor 51 to detect the value of the placed bets. For example, the bet sensor 51 may detect the magnetic or optical-sensitive indicators provided for chips wagered to generate the analog bet signal representing the value of the placed bet. In addition, a concave portion 504 is formed on the top surface 506 of tabletop 502 for receiving chips, which may be implemented with optical-sensitive or magnetic indicators for facilitating the bet sensors 51 to read the values of placed bets.

As mentioned above, the bet sensors 51 can simply be weight sensors that detect the weight of the chips to determine the value of the placed bets. A game display 55 is provided on the top surface 506 of tabletop 502 for showing information generated by the poker table 50 and received from the central management unit 30.

The poker table 50 further comprises a second digital encoder 52, a signal processor 53, a control unit 54, game display 55, and a second signal transmitter 56.

The second digital encoder 52 is embodied as an analog/digital converter converting the analog bet signal into a digital bet signal for convenience of signal communication and data processing. Accordingly, the second digital encoder 52 can be embodied as the digital encoder 22 of the poker dealing device 20 such that the bet sensor 51 is electrically linked to the digital encoder 22 of the poker dealing device 20 to encode the bet signal into the digital form. In other words, the bet signal is encoded into a digital form before the bet signal is transmitted to the central management unit 30, in step (2′).

The signal processor 53 responds to the digital bet signal to generate a bet management signal representing information that includes status of winning and losing, odds, and rewards for the placed bet so as to form the game record. The game display 55 is adaptive to selectively display the bet management signal of the game record, and the control unit 54 is adaptive to receive input commands to direct the signal processor 53 in handling the bet management signal. In step (2′), the second signal transmitter 56 is adaptive to transmit the bet management signal to and receive a control signal from the central management unit 30 through the communication means 40 in a wireless manner so that the central management unit 30 and dealer can communicate real-time in the course of the card game.

For example, the central processing unit 32 of central management unit 30 may include a program that calculates the odds and monetary results for winning and losing parties of the card games, and the calculated results may be transmitted from the signal receiving link 31 to the second signal transmitter 56 and displayed on the game display 55. Thus, the risk of miscalculating of the odds and winning or losing results by the dealer would be reduced. It is worth to mention that the second transmitter 56 can be embodied as the signal transmitter 24 of the poker dealing device 20 such that the bet senor 51 is electrically linked with the signal transmitter 24 of the poker dealing device 20 to transmit the bet signal to the central management unit 30 so as to minimize the component of the present invention.

In view of the foregoing description, the disclosed method has the following advantages. First, the method is capable reading the value and suit of a playing card 202 that is dispensing through its dispensing slot, so that the game record tracking the dealt playing cards 202 is therefore available. This reduces the chance of cheating and promotes the public's faith on the card games that adopt the disclosed poker dealing device 20. Furthermore, the poker dealing device 20 may be used in association with a deck of special playing cards 202 to ease the processing of the recognition of playing cards 202. The central management unit 30 and poker table 50 make enhanced managerial functions possible, wherein the calculation of status of winning and losing, odds, rewards and placed bets can be done accurately by the central management unit 30 and the related information can be provided to the dealer immediately. Thus, the disclosed card dealing system greatly helps the success of casinos' business.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1. A method for managing a card game by a poker dealing device through a central management unit, comprising the steps of:
(a) reading a card value of each playing card once said playing card is dispensed from said poker dealing device;
(b) transmitting said card values of said playing cards respectively dispensed from said poker dealing device as card signals to said central management unit; and
(c) recording said card signals to form a game record corresponding to said card game in such a manner that said card game is capable of being tracked by said card values of each hand of said card game, so as to reduce a risk of cheating in response to said playing cards dispensed from said poker dealing device.

2. The method, as recited in claim 1, in step (a), further comprising a step of providing a card reader at a dispensing slot of said poker dealing device for reading said card value of said playing card at a time when said playing card is dispensed out of said poker dealing device, so as to guarantee said card values of said playing cards in said poker dealing device in a secret manner until said playing cards are dispensed out of said poker dealing device through said dispensing slot.

3. The method, as recited in claim 2, in step (a), further comprising a step of providing a card indicator at said face side of each of said playing cards to represent said card value thereof, wherein said card indicator is positioned aligning with said card reader such that said card reader reads said card indicator when said respective playing card is dispensed out of said poker dealing device through said dispensing slot.

4. The method, as recited in claim 3, wherein said card reader is an optical scanning device reading a barcode of said card indicator on each of said playing cards when said playing cards are respectively dispensed through said dispensing slot of said poker dealing device.

5. The method, as recited in claim 3, wherein said card reader is a magnetic-sensor reading a magnetic-sensitive layer of said card indicator on each of said playing cards when said playing cards are respectively dispensed through said dispensing slot of said poker dealing device.

6. The method, as recited in claim 1, wherein said card signal is encoded into a digital form before said card signal is transmitted to said central management unit.

7. The method, as recited in claim 3, wherein said card signal is encoded into a digital form before said card signal is transmitted to said central management unit.

8. The method, as recited in claim 1, in step (b), wherein said card signal is wirelessly transmitted from said poker dealing device to said central management unit.

9. The method, as recited in claim 3, in step (b), wherein said card signal is wirelessly transmitted from said poker dealing device to said central management unit.

10. The method, as recited in claim 7, in step (b), wherein said card signal is wirelessly transmitted from said poker dealing device to said central management unit.

11. The method, as recited in claim 1, after step (c), further comprising a step of displaying said game record after said card game is over, wherein said game record is a record of said card game regarding a status of winning and losing and odds of said card game.

12. The method, as recited in claim 7, after step (c), further comprising a step of displaying said game record after said card game is over, wherein said game record is a record of said card game regarding a status of winning and losing and odds of said card game.

13. The method, as recited in claim 10, after step (c), further comprising a step of displaying said game record after said card game is over, wherein said game record is a record of said card game regarding a status of winning and losing and odds of said card game.

14. The method, as recited in claim 2, further comprising the steps of:
(a′) detecting a bet wagered within a betting area of a poker table to generate a bet signal representing a value of said bet;
(b′) transmitting said bet signal to said central management unit; and
(c′) recording said bet signal to generate said record in said central management unit such that said card game is capable of being tracked by said bet signals of each hand of said card game for determining a winning and losing result of each hand of said card game with respect to said card values of each said hand of said card game.

15. The method, as recited in claim 14, wherein said card signal and said bet signal are encoded into a digital form before said card signal and said bet signal are transmitted to said central management unit.

16. The method, as recited in claim 14, wherein said card signal and said bet signal are wirelessly transmitted to said central management unit.

17. The method, as recited in claim 15, wherein said card signal and said bet signal are wirelessly transmitted to said central management unit.

18. The method, as recited in claim 14, wherein said bet is detected by a weight of chips placed within said betting area to generate said bet signal representing said value of said chips.

19. The method, as recited in claim 15, wherein said bet is detected by a weight of chips placed within said betting area to generate said bet signal representing said value of said chips.

20. The method, as recited in claim 17, wherein said bet is detected by a weight of chips placed within said betting area to generate said bet signal representing said value of said chips.
